(19) United States
(12) Patent Application Publication
(10) Pub. No.: US 2025/0094230 A1
(43) Pub. Date: Mar. 20, 2025

(54) SYSTEM AND METHOD FOR INTELLIGENT RESOURCE SCHEDULE ADJUSTMENT

(71) Applicant: Nice Ltd., Ra'anana (IL)

(72) Inventors: Amichai UNGAR, Bruchin (IL); Noam Zeev KAPLAN, Tel-Aviv (IL); Tamir KASHANI, Raanana (IL)

(73) Assignee: Nice Ltd., Ra'anana (IL)

(21) Appl. No.: 18/468,976

(22) Filed: Sep. 18, 2023

(51) Int. Cl. G06F 9/50; G06F 11/34

(52) U.S. Cl. CPC G06F 9/5038; G06F 9/5016; G06F 9/5072; G06F 11/3457

(57) ABSTRACT

A computerized system and method may calculate or update task or job execution schedules for a plurality of resources and perform automated actions based on the calculated or updated schedules. A computerized system including one or more processors, a memory, and a communication interface to communicate via a communication network with remote computing devices, may be used for forecasting or reforecasting task properties for relevant time intervals, where the properties may describe future tasks to be handled by a plurality of resources; calculating an allocation matrix for the time intervals based on the predicted properties; and calculating or updating a schedule based on the calculated allocation matrix—for example to automatically extend a break for one or more resources, where resources are not to handle tasks during the break. Some embodiments of the invention may perform, e.g., computer automated actions based on calculated or updated schedules.

### FIELD OF THE INVENTION

The invention described herein relates to the field of automatic allocation and scheduling of resources for performing diverse tasks, and more particularly to intelligent, automatic adjustments of previously determined schedules.

### BACKGROUND OF THE INVENTION

Different systems and methods exist to handle the problem of resource allocation and/or scheduling, such as computer system resource allocation or scheduling, or generating allocation requirements—e.g., how many resources or “agents” are needed in each time interval-given or based on appropriate constraints, such as for example a workload or volume of tasks to be handled by the resources or agents. Some resources (such as for example computer processing units, as well as human agents) may be able to handle a plurality of different tasks—such as for example concurrently transmitting messages, data items or signals across multiple channels such as web chat, email, and short message service (SMS); or performing different kinds of computations such as, e.g., handling both short, storage or disk undemanding jobs as well as I/O intensive jobs. Other examples of resources or agents, as well as functions or “skills” which they may possess and use to perform tasks may easily be realized. While some systems and methods for resource allocation and scheduling exist, there is a need for novel systems and methods for optimizing resource usage and preventing undue attrition and degradation of resources—for example by ensuring resources or agents are not exhausted by excessive use, e.g., by dynamically scheduling rest or break periods or intervals during which resources may not perform any task, be recharged or rebooted, and the like.

### SUMMARY OF THE INVENTION

A computerized system and method may calculate, update or adjust task execution schedules for a plurality of resources and perform automated actions based on the calculated or updated schedules. A computerized system including one or more processors, a memory, and a communication interface to communicate via a communication network with remote computing devices, may be used for predicting, forecasting, or reforecasting, a plurality of task properties for a plurality of relevant time intervals, where each of the task properties may describe one or more future tasks to be handled by one or more resources; calculating an allocation matrix for the time intervals based on the predicted properties; and calculating or updating a schedule based on the allocation matrix—for example to automatically extend a break for one or more resources, where resources are not to handle tasks during the break.

Some embodiments of the invention may perform or execute a schedule calculation or adjustment procedures at a point in time within the time intervals considered (such as for example halfway through a given time interval), and based on data describing tasks already executed within these time intervals—which may be referred to herein as running a scheduling or rescheduling process in a “mid interval” fashion.

In some embodiments, predicting task properties may include weighting or normalizing past predictions of task properties for the time intervals considered, which may include comparing the past predictions or previously predicted values to a plurality of past task data, which may describe tasks already handled during the time intervals considered. Past task data may include, e.g., start and end times of a plurality of tasks handled, and state data describing past activities and handling of tasks by relevant resources.

Some embodiments may calculate an allocation or assignment matrix using an allocation requirement simulation and based on predicted or calculated task properties, numbers and types of resources available to perform or handle tasks during the relevant time interval or intervals, and past task data used as inputs for an appropriate simulator.

In some embodiments, resources for which breaks may be created or extended may be selected randomly form a set or list of extension candidates.

Some embodiments of the invention may perform automated actions based on schedules determined or provided using the various protocols and procedures outlined herein-which may include for example transmitting a task execution command to a resource (such as for example physically separate or remote computer over a communication network), where the resource is to automatically execute, or to cancel an execution, of at least one computer task based updated schedule.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a high-level block diagram of an exemplary computing device which may be used with embodiments of the invention.

FIG. 2 is a high-level diagram of an example break adjustment system integrated into a workforce management service according to some embodiments of the invention.

FIG. 3 shows an example break adjustment system integrated into a contact center environment according to some embodiments of the invention.

FIG. 4 shows an example system for resource scheduling in a contact center environment according to some embodiments of the invention.

FIG. 5 shows an example break extending algorithm according to some embodiments of the invention.

FIG. 6 shows an example schedule and forecasting results according to some embodiments of the invention.

FIG. 7 shows an example user interface for displaying schedule modifications according to some embodiments of the invention.

FIG. 8 is a flowchart depicting an example method for intelligent resource schedule adjustment according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Embodiments of the invention may be used for scheduling or rescheduling resources for performing various tasks, and for modifying or adjusting “breaks”—which may be used herein to refer to time intervals or time periods during which resources may be idle and may not perform or handle tasks (for example, breaks may refer to a time interval or period during which a computer system is to be rebooted, or be kept shut down). In some embodiments, it may be desirable to create, adjust, or extend breaks in order to optimally use, and not to exhaust, the resources under consideration; particular examples for breaks may include, e.g., rebooting a computer system for clearing cache memory, or requiring a computer processing unit to be shut down, so it may cool down in order to prevent hardware damages and risks.

It should be emphasized that while some embodiments of the invention are discussed or considered herein as relating to allocation or assignment of human agents or resources, e.g., in a call or contact center environment, different embodiments of the invention may generally be used for resource allocation tasks in a great variety of technological environments. For example, some embodiments of the invention may be applied, e.g., to the allocation of computational resources (including, but not limited to, processing and/or memory and/or storage units) in a data center or high-performance computing cluster environments. Thus, discussions relating to, e.g., contact center environments, should be considered non-limiting, and anthropomorphic terms such as “agent”, “skill” and the like, should be considered as being applied to analogous entities, e.g., terms such as, e.g., “resource”, “feature”, “function” and the like.

As used herein, “Call Center” may refer to a centralized office used for receiving or transmitting a large volume of interactions which may include, for example, enquiries by telephone. An inbound call center may be operated by a company (e.g. a tenant) to administer incoming product or service support or information enquiries from consumers.

As used herein, “Contact Center” may refer to a call center which handles other types of communications other than voice telephone calls, for example, email, message chat, SMS, etc. Reference to call center should be taken to be applicable to contact center.

As used herein, an “Agent” may be a contact center employee that answers incoming contacts, handles customer requests and so on—although, in the context of the present disclosure, “Agent” should be considered as a non-limiting example for a resource being able to perform tasks, which may or may not be human (and may be, for example, computational).

As used herein, a “Customer” may be an end user of a contact center. They may be customers of the company that require some kind of service or support.

As used herein, “Work Force Management (WFM)” may refer to an integrated set of processes that a company uses to optimize the productivity of its human resources. WFM involves effectively forecasting job or task requirements and creating and managing agent schedules to accomplish a particular task on a day-to-day and hour-to-hour basis.

As used herein, “Allocation Requirements” may refer to the required amount of resources (such as, e.g., the number of agents at a contact center) needed or required, or having the capacity to handle expected contacts in accordance with quality-of-service metrics. As further demonstrated herein, an allocation matrix, such as for example provided in Table 2, may describe a plurality of allocation requirements for a plurality of skills and time intervals (similarly, an allocation vector may be, e.g., an allocation requirement for a single skill or for a single time interval). An allocation matrix or vector describe may for example describe work capacity expected to be required for handling a plurality of future tasks by a plurality of resources in aggregate (where particular or specific tasks may not be specified or associated with, or scheduled to, specific resources—and where the future tasks are considered by collective task properties such as average handling time and volume—see corresponding discussion herein).

As used herein, “Workload” may refer to the overall amount of work to be handled or being received. In the example of a call center, workload may be work arriving at the call center. In other examples, e.g. where resources are computer hardware or software resources, workload may be measured differently. Workload may be calculated as a factor of volumes, average handling time, and customer latency, as well as others. Workload may be broken down into one or more features or skills, e.g. a workload may be given which is broken down or otherwise characterized by a workload for (or requiring using) a first skill and a workload for a second skill.

As used herein, “Volume” may refer to a number of tasks or “contacts” coming into a contact center. Workload and volume may also relate, for example, to contact center occupancy—which may measure or quantify how far a contact center is or should be from working at its full capacity (e.g., from a maximal utilization or exhaustion of resources), and thus to various service metrics and targets as further described herein.

As used herein, “Average Handling Time (AHT)” may refer to the average time from start to finish of a task such as, e.g., a customer interaction. AHT may be an important factor in understanding how much work (e.g. workload) the contact center is handling/will handle. As used herein, “Customer Latency” may refer to a measure describing how long on average a customer takes to respond to an agent after the agent has replied. This measure may be an important factor in quantifying the workload in the digital contact center.

As used herein, “Skills” may refer to a method of compartmentalizing resources or features attributed to resources, such as for example agent training and specialty into different useful categories, e.g. technical support, financial inquiries and so on. Skills may also be used as a means of representing different channels of communication such as voice, chat etc., where tech_support_voice could be one skill and tech_support_chat could be another. If a resource or agent possesses a skill or feature—the resource or agent may handle a task corresponding to that skill or feature (for example, an agent having a “customer support” skill may handle customer support calls, while agents not having such skill or feature may not handle such calls).

As used herein, “Under/Overallocation” may refer to situations when the contact center may not be working effectively, and resources may be wasted. When overallocated or overassigned, resources or agents may not be fully utilized. When underallocated or underassigned, tasks may be handled poorly in terms of resource or agent availability (for example, customers may be waiting longer times for their call to be answered by an agent). As demonstrated herein, positive allocation matrix entries may indicate that resources may be, for example, overallocated/underallocated, or may have the capacity of handling more/less tasks than required or needed using a given skill within or throughout a given time interval.

As used herein, “Forecasting” may refer to the process or generating data, or for the data generated for describing a selected time interval or period, often starting from the present or from the end time of the current schedule.

As used herein, “Schedule” may refer to a queue or set of time intervals or time periods during which a resource or agent may be assigned a plurality of tasks, e.g., of a particular type or skill. A schedule may describe for example particular tasks that may be assigned to a particular resource within a specific time interval. Schedules used by embodiments of the invention may be provided and/or stored in different formats, such as for example in JSON or CSV formats, although additional or alternative formats may be used. An example schedule for a single resource is described in the example in Table 1:

TABLE 1

| Time Interval | Resource A | Resource B | . . . |
|---|---|---|---|
| . . . | . . . | . . . | . . . |
| 08:30-09:00 | Quartic Optimization | Break | . . . |
| | Calculation | | |
| 09:00-09:30 | Storage Backup | Storage Backup | . . . |
| 09:30-10:00 | Break | Quartic Optimization | . . . |
| | | Calculation | |
| . . . | . . . | . . . | . . . |

### Table 1.

One skilled in the art may recognize that many different schedules may be realized and used in different embodiments.

Embodiments of the invention may include or involve executing a resource scheduling or rescheduling algorithm such as, e.g., example Algorithm #1—which may be performed or executed, e.g., using the various systems considered herein:

### Algorithm #1:

Start
Execute a forecasting or reforecasting process for predicting or computing a plurality of properties or metrics, which may describe a plurality future tasks or jobs to be handled by a plurality of agents or resources (where the properties may describe the future tasks or jobs, and may be or may include, e.g., updated task volumes and/or AHTs) for a plurality of time intervals (e.g., one or two) ahead of a given break end time for a resource or resources;
Calculate or compute an allocation or assignment matrix—for example based on predicted properties or metrics—where the allocation matrix may describe a capacity of the relevant resources to handle the future tasks. In some embodiments, calculating or computing an allocation matrix may include executing an allocation requirement simulation (which may, e.g., be triggered with the receiving of states of relevant agents measured mid interval), and output a list of skills that may be overallocated for the time intervals considered;
List a plurality of agents on a break that may have only over-allocated or overallocated skills (which may also be referred to herein as skills or resources allocated in excess, e.g., to skills or resources that may be removed without harming the remaining resources capacity to handle the relevant tasks or jobs for a given time interval). Such agents may also referred to herein as “break extension candidates”;
Shuffle/reorganize break extension candidate list;
While the extension candidate list is not empty:
   Remove/subtract a given or “next” candidate from a net allocation (as described, e.g., using an allocation matrix) for the relevant time interval;
   If the net allocation remains positive, update net-allocation and adding an agent (e.g., from the list of extension candidates) to a break extension list;
   If subtraction results in a negative net-allocation, remove all break extension candidates with same skill set from the list of extension candidates;
Based on the subtraction and corresponding allocation matrix, update a schedule or schedules of relevant agents with break extensions (which may include, e.g., automatically extending a break or breaks for relevant agents or extension candidates) and send notification to agents selected for break extension X minutes (e.g., X=5 minute) before original break;
End
   It should be noted that additional or alternative steps may be included in different scheduling or rescheduling algorithms and/or protocols according to different embodiments of the invention. The various operations included in Algorithm 1 will be discussed further and in greater detail herein.

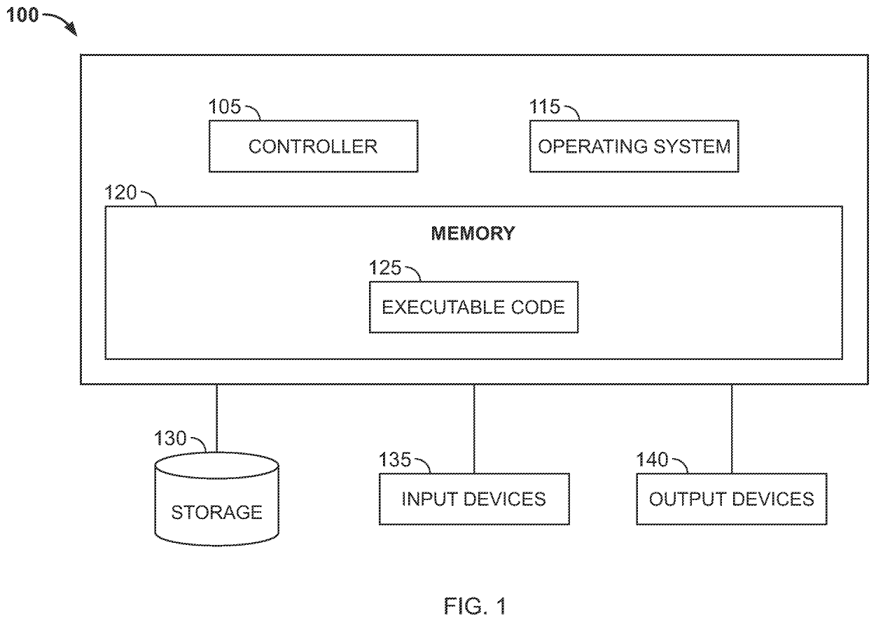

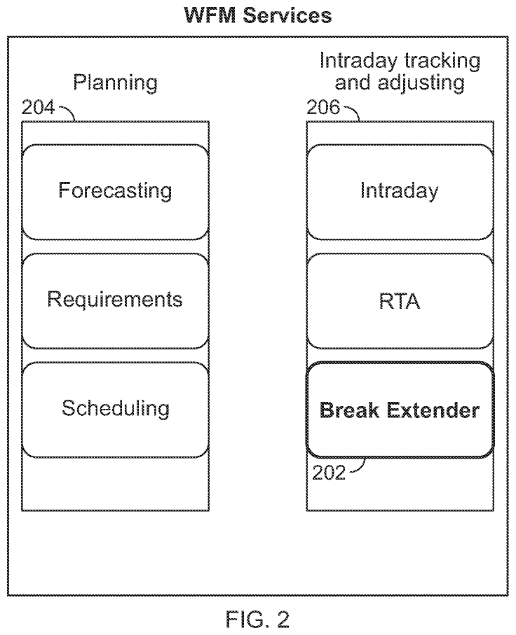

FIG. 1 shows a high-level block diagram of an exemplary computing device which may be used with embodiments of the invention. Computing device 100 may include a controller or processor 105 (or, in some embodiments, a plurality of processors) that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of the procedures and/or calculations discussed herein, and the modules and units discussed, such as for example those included in FIGS. 2-8, may be or include, or may be executed by, a computing device such as included in FIG. 1, although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or a data store of a plurality of data items describing one or more remote computing devices as further disclosed herein.

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIGS. 2-8 according to embodiments of the invention. In some embodiments, more than one computing device 100 or components of device 100 may be used for multiple functions described herein. For the various functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the invention by for example executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data describing one or more remote computing devices, as well as additional and/or different data items, may be stored in a storage 130 and may be loaded from storage 130 into a memory 120 where it may be processed by controller 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out functions, methods and procedures as disclosed herein.

It should be noted that a plurality of physically separate computer systems and/or computational resources which may or may not correspond to the architecture of system 100 (and may include for example ones provided via cloud platforms and/or services) may be for example connected via a data or communication network as a multi-memory and/or processor system, which may be used in some embodiments of the invention. Those skilled in the art may recognize that a plurality of computer system architectures may be used in different embodiments of the invention.

FIG. 2 is a high-level diagram of an example an example break adjustment system integrated into a workforce management service according to some embodiments of the invention. Some embodiments of the invention may be integrated into existing workforce management (WFM) systems and methods, for example as a dedicated “break extender” subcomponent or module 202. Some WFM systems and methods, such as for example the Work Force Management Software by NICE Ltd. (additional examples are known in the art of WFM), may be broken into two main components or parts—(a) planning in advance 204 (which may include, e.g., forecasting of task data, such as, e.g., described herein) and (b) real time or intraday tracking and adjusting 206 (which may be focused on collecting and processing data relating to tasks performed or being performed by resources or agents). Some embodiments of the invention may be integrated, e.g., into tracking and adjusting component 206, and for example communicate with planning in advance component 204, to automatically adjust schedules and agent breaks as further discussed herein.

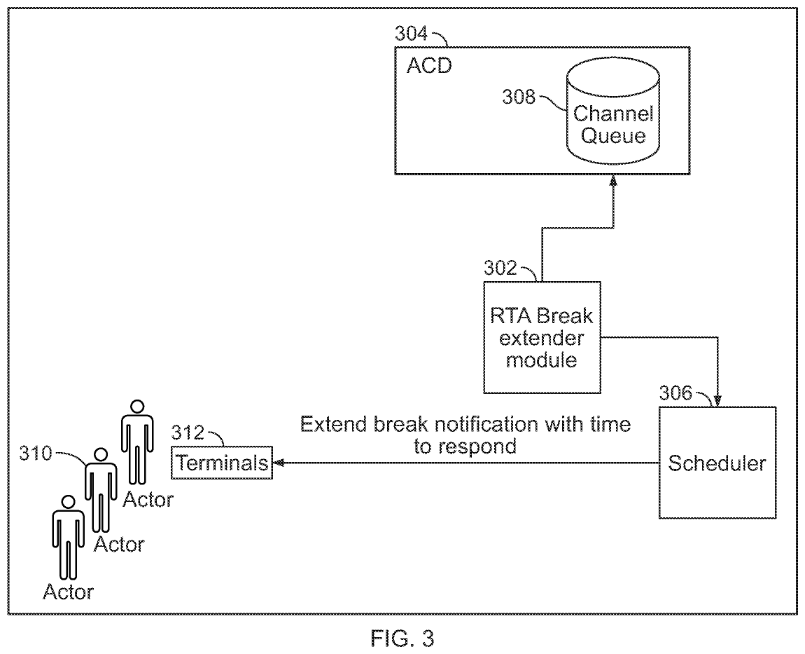

FIG. 3 shows an example break adjustment system integrated into a contact center environment according to some embodiments of the invention. Some embodiments of the invention may include a real time adherence (RTA) break extender component or module 302 (such as, e.g., module 202) which may connect an automated call distributor component (ACD) 304 and a scheduler component or module 306. ACD 304 may include a channel queue 308, and may be used for routing a plurality of interactions (over a plurality of different channels, such as e.g., voice over internet protocol (VOIP), online chat or SMS messaging, and so forth, as known in the relevant arts relating to contact center systems). Scheduler 306 may send, provide or transmit schedules, for example over a communication network, to agent terminals 312, to be viewed by agents or actors 310, or to other physically separate or remote computers operated by agents or actors 310, which may describe or correspond to, e.g., future routings of tasks by ACD 304 to relevant agents. In some embodiments, agent terminals may be for example computer systems conforming to the architecture of system 100—and inputs from an agent or actor, and/or displays an agent or actor, can be received and/or processed using an agent terminal.

In some embodiments, RTA break extender 302 may be fed, for example, by or from ACD 304 with task data or with state data—which may, e.g., describe or reflect agents' states and/or a contact center's state (e.g., while tasks are being handled), and/or change to such states. In some embodiments, state information may include or describe both what an agent is doing (handling a voice call, handling multiple chats, has 3 emails waiting for him, etc. —as well as states such as, e.g., “available”, “logged-out”, “on break”, and so forth) as well as a general task or interaction queue overview, e.g., from channel queue 308—which may for example include the data or information of pending interactions of a specific channel (such as for example properties or attributes of pending VOIP interactions, which have not yet been scheduled or routed to agents, where properties or attributes may include, e.g., a level of urgency such as “low”, “medium”, “high”, etc., requested for the task, or properties of the party requesting the task. Many additional or alternative task and/or channel attributes or properties may be realized). In some embodiments, a general queue overview which may for example be included in state information may describe how many items (such as, e.g., interactions) are waiting or pending with reference to different topics, labels, skills or agents—such as, e.g., 10 voice calls waiting or pending for “customer support”, 0 calls waiting or pending for “billing information”.

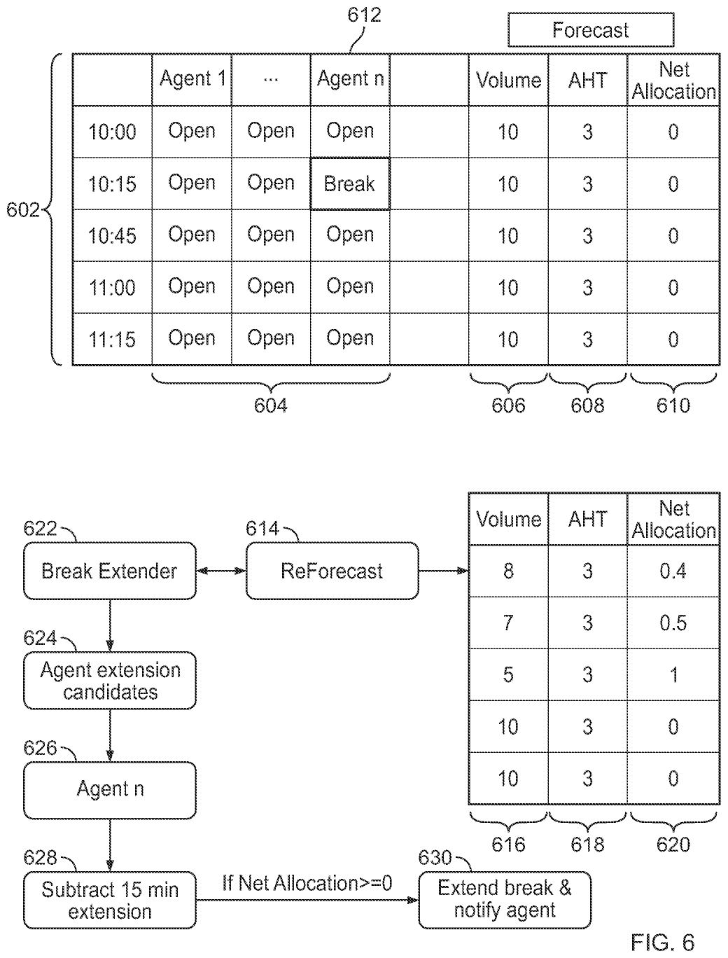

Scheduler 306 may store, hold or include the data of an agent's upcoming schedule and enable or allow its modification. Nonlimiting example schedules may be seen, e.g., in Table 1 and FIG. 6. Some embodiments may use scheduler 306, which may be triggered or accessed by break extender 302, for example as part of recalculating scheduling and/or allocation or assignment requirements, and/or as part of updating the schedule when an agent's break may be extended, and/or to perform additional operations considered as part of a break extending algorithm such as for example described herein. Scheduler 306 may also update, or send alerts or notifications to agents or actors 310, as well as to remote computing devices (which may, e.g., be operated by supervisors and other relevant contact center personas) as further described herein. Data generated and/or collected and/or gathered by different components may for example be stored in relevant databases or appropriate data structures in computer memory (such as, e.g., memory 120).

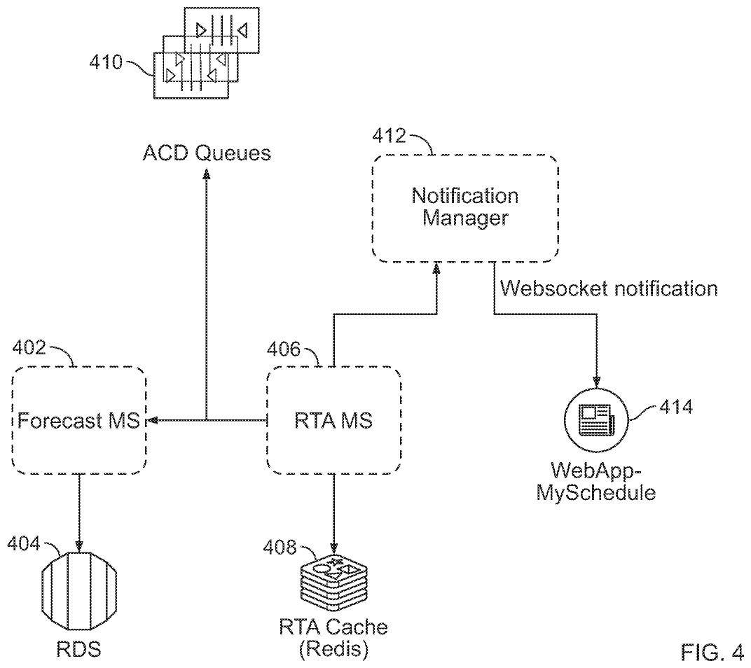

In some embodiments of the invention, a break extender component such as components 302 may be triggered by an RTA component (such as for example described herein with reference to FIG. 4) to which it may be integrated, e.g., in the middle of time intervals and/or when at least one agent may be on break, to initiate a break extending procedure or algorithm such as for example described herein.

Routing of tasks of interaction such as for example using ACD 304 may be performed using or according appropriate data structures, such as tables describing the task routed, the requester or source node (e.g., a caller) associated with the task, and the destination (e.g., a resource or agent) to which the task may be routed and that may be responsible for handling or executing the task. In this context, different routing schemes and appropriate data structures are known in the art of network and/or data routing and transmission.

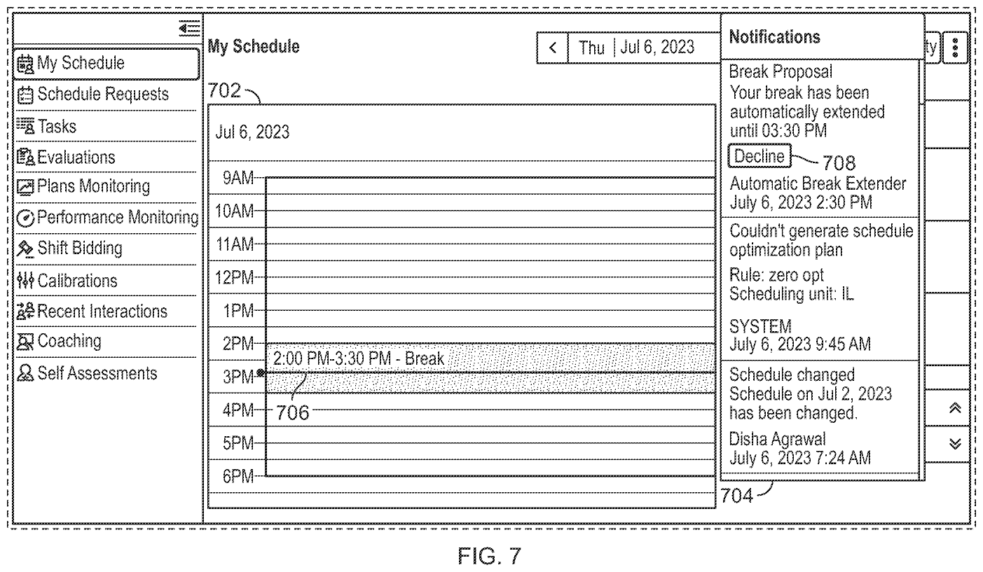

Alerts or notifications which may be generated and/or transmitted by different embodiments of the invention may be provided and/or stored in different formats, such as for example in JSON or CSV formats, although additional or alternative formats may be used. A nonlimiting example alert may be seen in FIG. 7; see also corresponding discussion herein.

Embodiments of the invention may determine or execute real-time operations and actions and/or provide schedule changes or adjustments to contact center components (including, e.g., changing a routing by ACD 304 and/or a schedule by scheduler 306)—for example, within or during a given time interval in which at least some tasks were already executed-based on updated task data or channel queue information such as for example described herein. Performing scheduling related operations during a time interval in such manner may also referred to herein as performing such operations “mid interval”.

FIG. 4 shows an example system for resource scheduling integrated into a cloud platform environment according to some embodiments of the invention. In this figure, the Amazon Web Services cloud platform and its constituent components may be considered as a non-limiting example for a cloud platform to which some embodiments of the invention may be integrated—although additional or alternative examples may be considered. In some embodiments, a forecast microservice (MS) 402 may calculate a plurality of properties or metrics describing future tasks (such as for example a volume and expected handling times or AHTs for tasks which may be currently unknown and may be handled by a plurality of resources in future time intervals), for example based on past tasks or interactions already handled, and/or based on statistics and information describing the handling of such past tasks. In some embodiments, forecast MS may perform the various scheduling and forecasting related operation described herein, in addition to additional or alternative workforce forecasting and scheduling operations such as, e.g., ones provided by the Workforce Management Suite by NICE Ltd.—although additional or alternative forecasting techniques are known in the art of WFM and may be used in different embodiments. Relational Database Service (RDS) 404 may be or may include a relational database which may be used, for example, for storing forecasted data such as, e.g., described herein. Real Time Adherence (RTA) MS 406 may collect or store task or interaction data, and/or current states of an agent, or of a plurality of agents, e.g., at a given moment in time—and may also for example compare the states with a reference schedule for the agent or agents, and/or flag or mark an adherence, or a discrepancy between the agent's or agents' state and a corresponding reference schedule, in real time. RTA Cache 408 may be a cache layer used by the RTA MS to store or keep agents' schedule event such as, e.g., task data and/or agent states (e.g., in addition to related metadata such as for example various identifiers and/or activity codes for relevant agents or tasks) and its current state. In some embodiments, RTA Cache 408 may be, e.g., a Redis cache, although other memory structures and cache types may be used in different embodiments. ACD Queues 410 may be or may include or store task or interactions queues, which may for example describe interactions or tasks pending to be handled or completed by an agent or resource. In some embodiments, ACD queues 410 may for example be fetched from or into an ACD component such as for example ACD 304. As noted herein, each channel, skill, or feature may have a distinct and separate queue (such as for example one queue of pending tasks or interactions for “customer support”, and a second queue of pending tasks for “sales”) in some embodiments of the invention—while in other embodiments, for example, multiple skills may have a single queue. A notification Manager component or module 412 may “push”, send, or transmit updates or adjustments (such as, e.g., schedule updates or adjustments) to relevant agent or agents. WebApp-MySchedule 414 may be, in some embodiments, a user interface operated or used by a given agent and displaying his or her schedule (such as for example illustrated in FIG. 7). Clearly, in some embodiments of the invention where no human agents are considered (e.g., in embodiments including only computer and/or hardware resources)—some components included in FIG. 4 such as, e.g., WebApp-MySchedule 414 may be omitted. Additional or alternative components may be included in different embodiments of the invention.

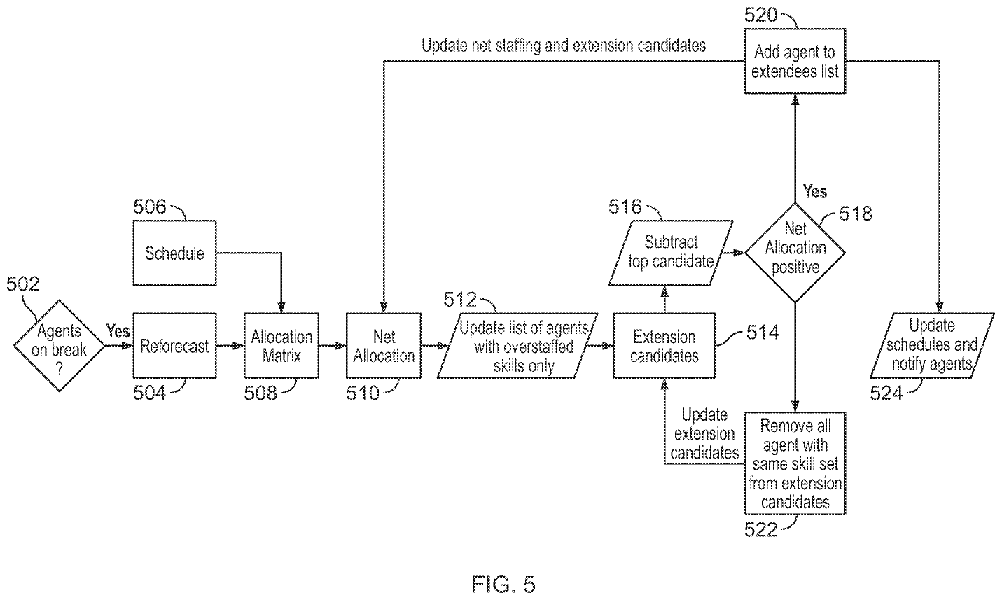

FIG. 5 shows an example break extending algorithm according to some embodiments of the invention.

Agents on break 502: in some embodiments, a requirement or condition for the algorithm to be initiated or activated may be having agents that are on a break at a given point in time (e.g., at the present moment). If this condition is satisfied, the algorithm or process may begin running by fetching the present states or statuses of a plurality of agents from an RTA component or service such as, e.g., described herein with reference to FIG. 4 (which may store or document all the agents with their current states such as, e.g., explained herein).

Forecast/Reforecast 504: embodiments may use newly accumulated data to calculate, predict or compute (or to recalculate, e.g., in case previous forecasts were already calculated, predicted, or computed) a plurality of properties or metrics—which may describe a plurality of future tasks or jobs to be handled during future time intervals or intervals subsequent to the one during which a scheduling algorithm may be executed.

In this context, properties or metrics may be or may include for example expected statistics and/or service metrics such as, e.g., a number or volume of tasks or jobs and/or an AHT of tasks or jobs (such as for example calls coming into the contact center). In some embodiments, forecasting and/or reforecasting of task properties may be performed, e.g., using forecast MS 402 as, e.g., described herein. Future task data, properties or metrics may be forecasted by embodiments of the invention to describe a plurality of incoming tasks or interactions, which may for example be grouped or categorized into a plurality of skill queues (where each queue may include or contain task of a given skill; a nonlimiting example skill queue may be seen in FIG. 6—see corresponding discussion herein).

In some embodiments of the invention, a reforecasting protocol may be or may include, e.g., weighting or normalizing past or prior predictions, which may be for example previously computed task properties or metrics, or task properties or metrics computed for, and prior to, the time interval or intervals considered—based on past task data. In this context, past task data may be or may include or describe start and end times for tasks or jobs already handled within the relevant time intervals and prior to the initiation of the scheduling procedure (e.g., before the mid interval point in which the algorithm may be executed). Past predictions, or previously forecasted data or metrics, may thus be compared to historical, measured, past task data (including, e.g., agents' states during the time intervals which may indicate if agents were handling or completing tasks), for example in order to correct for biases, errors, or discrepancies between forecasted data describing actual task or agent activity within the time interval or intervals considered. In this context, a forecasting or reforecasting process be performed, e.g., using initial or past forecasted or predicted data as input and, e.g., according to the following nonlimiting example definitions and formulas:

$$N ≡ number of time intervals passed since the prediction was originally made or computed \qquad ( Eq . 1 )$$

$$R , or “ reality factor ” ≡ ( N / N + 1 ) \hat{} 2 \qquad ( Eq . 2 )$$

$$X ≡ ( actual quantity measured or calculated for time interval t until mid interval point ) / ( forecasted quantity for time interval t ) \qquad ( Eq . 3 )$$

Where, e.g., for a quantity such as the number of tasks handled by a given resource, if X<1, then the agent or resource may be considered as underachieving or underperforming with respect to forecasts or predictions; similarly X>1, may indicate the agent or resource may be overachieving or overperforming; and X=1 may indicate a correspondence between forecast and performance. Given—

$$F ≡ forecast value \qquad ( Eq . 4 )$$

F may be reforecasted, updated or recalculated (denoted F′ herein), for example, according to:

$${F}^{′} = X * F \qquad ( Eq . 5 )$$

Or, e.g., according to:

$${F}^{′} = F + ( X * F - F ) R = F ( 1 + R ( X - 1 ) ) \qquad ( Eq . 6 )$$

It can be seen that F may substituted for example, by a plurality of input forecasted or predicted values, such as for example ones relating to task AHT, for instance:

$$AHT ≡ total duration of tasks in seconds / number of tasks \qquad ( Eq . 7 )$$

$$AHT ’ = X ( AHT ) = [ AHT ( actual for time interval t until mid interval point ) / AHT ( forecasted for time interval t ) ] * AHT ( forecasted for time interval t ) \qquad ( Eq . 8 )$$

to produce recalculated AHT values (which may be denoted, e.g., AHT′) based on newly measured input data for forecasting. Additional or alternative formulas may be used in different embodiments of the invention.

Schedule 506: in some embodiments of the invention, a schedule may be or may include, e.g., a matrix or vector product of shape or format (|agents|×|time intervals|)—which may hold, store or include a calendar with all the agents which may be scheduled or handle tasks during each of a plurality of time intervals. As demonstrated herein, a schedule may include, e.g., shifts of the working agents and various tasks and/or activities like meetings, breaks, trainings and more. Example schedules may be seen, e.g., in Table 1 and FIG. 6. An agent may generally comply to, act, and handle tasks according to his schedule, which may mean, e.g., answering calls on shift and be on a break and note handle tasks in time periods, intervals or subintervals labeled or determined as breaks. Embodiments may calculate, update, adjust or modify agent's schedules such as, e.g., described herein.

Allocation matrix 508—Embodiments of the invention may calculate or obtain an allocation matrix for the time intervals considered for scheduling. Some embodiments of the invention may run or execute a requirements simulator, e.g., using the inputs from 504 and 506. For example, during or within a given time interval considered for schedule adjustments or for rescheduling, embodiments may run a simulation based on (re) forecasted values or task properties; and/or a set of available resources, or resources available to perform tasks for the time interval considered; and/or actual states data, or data describing the states of resources at a specific point in time (e.g., mid interval); and/or a plurality of past task data or data describing, e.g., past time intervals or tasks handled prior to running the simulation or prior to the mid interval state in which the scheduling process may be initiated (including for example their start and end data)—to provide, compute or calculate allocation requirements, e.g., in the form of an allocation or assignment matrix or matrices, as further discussed herein. The output of a simulator run may be, e.g., an allocation requirement matrix of shape or format (|skills|×|time intervals|) for each interval of a plurality of time intervals—which may for example describe a number of resources of agents capable of performing or handling jobs or tasks of a given skill, which may be required for the execution of a forecasted or incoming volume of tasks of that skill for the relevant time interval (such as, e.g., the ones forecasted at 504), and/or for example describe a capacity of the resources to handle the relevant (e.g., future) tasks. An allocation matrix may thus include rows—each row corresponding to a time interval; and columns—each column corresponding to a skill or feature. Each entry in the allocation matrix may describe or indicate a number of resources needed or required to perform or execute a given (e.g., forecasted or scheduled) number of tasks for the time interval considered. A nonlimiting example allocation matrix is illustrated in Table 2:

TABLE 2

| | Skill A | Skill B | . . . |
|---|---|---|---|
| 08:00-08:30 | 3 | 2 | . . . |
| 08:30-09:00 | 4 | 1 | . . . |
| . . . | . . . | . . . | . . . |

and may be used for describing allocation requirements and/or an actual allocation such as for example described herein. One skilled in the art of resource allocation and/or scheduling may recognize that various additional or alternative allocation data structures, and/or procedures for obtaining or calculating allocation matrices may be used in different embodiments of the invention.

Net allocation 510: as part of calculating, computing or outputting an allocation or assignment matrix, embodiments may calculate a difference between how many agents may be needed (e.g., based on the newly calculated allocation requirements or the matrix from 508) and how many agents may be available (e.g., based on a schedule or schedules from 506, which may, in combination, be considered as an “actual allocation” or “actual assignment” as further described herein). These values may be calculated per skill, and could be both positive or negative. Positive values may imply overallocation in a specific skill, which may suggest that agents may be idle during at least part of the time interval considered, while negative values may imply underallocation, which may suggest agents waiting or working longer than expected or desired for that time interval.

In some embodiments, the net allocation may be calculated as, e.g.:

$$allocation requirements - actual allocation \qquad ( Eq . 9 )$$

although additional or alternative expressions or formulas may be used in different embodiments. As an illustrative, non limiting example, for a contact center with 3 skills A, B, C (e.g., a contact center handling tasks requiring one or more of skills or features A, B, C from agents or resources)—an allocation requirement for a given or next (e.g., upcoming) interval may be for example a row vector of [2, 4, 5]-which may indicate that 2 agents may be required for skill A, or that 2 agents may have the capacity for handling incoming tasks using skill A during that interval; 4 agents may be required for skill B; and 5 agents may be required for skill C. If the actual allocation (which may for example describe a contact center during the time interval for which the allocation requirements were generated, or describe a future state of a contact center based on schedules determined for a plurality of relevant agents) consists of 3 agents with skills A, 4 agents with skill B, and 4 agents with skill C, represented as [3, 4, 4], the net allocation may be: [1, 0, −1]. For this example, skill A may be overallocated by 1 agent while skill C is underallocated by one agent. A nonlimiting example net allocation matrix (considered for a single skill, hence expressed as a vector) for a plurality of time intervals may be seen in FIG. 6—see also corresponding discussion herein.

Update list of agents with overallocated skills only 512: embodiments of the invention may filter or extract a list of agents having skills indicated as overallocated by the net allocation, e.g., as calculated in 510. Using the same illustrative, non limiting example regarding a contact center of skills A, B, C and a net allocation of [1, 0, −1], it may be understood that only skill A is overallocated. Hence, only the agents with skill A and no additional or other skills may be selected or filtered, and be included or added to a list. The list of agents after filtering, in this case, would be the 3 agents with skill A. These 3 agents may be considered break extension candidates in subsequent steps such as for example described herein.

Extension candidates 514: in accordance with the discussion herein, a collection or set of agents which may be included in the list created in 512 and for which all skills are overallocated may be referred to as break extension candidates. In some embodiments, extension candidates may be agents or resources that, even if they may be on a break, or if their break may be extended, the net allocation will not be negative (and indicate underallocation) for their corresponding skills.

In some embodiments, the list of candidate agents satisfying this condition may be randomized—for example to ensure fairness to agents such that each time different agents will get their break-time extended—e.g., according to the removing of the top agent on the candidate list as further described herein. In such manner, schedule updates and adjustments such as for example further described herein may be performed for randomly selected resources, e.g., among the resources considered as extension candidates. One skilled in the arts of resource or task scheduling may recognize that additional considerations for randomization may be considered for non-human resources in different embodiments of the invention.

Subtract or remove top candidate 516: as part of calculating an allocation matrix, embodiments may remove a plurality of resources or agents, such as for example the top agent, or agent named first on the list, from the current allocation or schedule to check whether this change is feasible and does not result in negative net allocation. For example, if the net allocation is [1, 0, −1], creating or extending a break of 1 agent with skill A may result in net allocation of [0, 0, −1] for the time interval during which the relevant agent would cease to work.

Net allocation positive? 518: A schedule update or change (e.g., as may be performed or obtained for example in step 524 and as described herein) may be considered feasible or allowed if it will not result in any of the skills becoming underallocated. Thus, if the net allocation or net assignment remains positive, an agent's break can be extended. Given a net allocation of [1, 0, −1], it may be seen that a net allocation of [0, 0, −1], after the subtraction of a candidate agent, e.g., as may be performed in 516, did not become negative. Thus, in such an example, a schedule change may be made without harming service or task handling—and embodiments may proceed to 520. Otherwise, if a net allocation entry is found negative, embodiments may proceed to 522. Embodiments may thus check, for a plurality of positive matrix entries (e.g., entries above zero, for a given skill in the allocation or net allocation matrix such as, e.g., 1 in [1, 0, −1] or in NetAllocation 620 in FIG. 6)—which may represent overallocation or excess allocation or excess assignment for a relevant time interval or intervals—if it may be possible to remove an agent or resource (such as for example extension candidates associated with the relevant skill) from the matrix without making some matrix entries negative (which may result in underallocation).

Add agent to extendee list 520: if no negative matrix entries are introduced as a result of subtraction or removal (as performed, e.g., in 516), the relevant agent or agents may be added to a list of “break extendees”—which may be agents for which a break may be created, augmented, extended, or scheduled within the time interval under consideration. Break extendees' schedules, or planned or scheduled activity may automatically be changed or updated by embodiments of the invention, and the net-allocation may be recalculated by embodiments of the invention (e.g., the algorithm or process may proceed or return to 510). If no more candidates may be added to the extendee list without inducing negative net allocation, the algorithm or procedure may proceed to 524.

Remove all agents with same skill set from extension candidates 522: if the agent's break may not be removed without causing the net allocation in some of the skill to become negative, this agent, and every other agent with the exact same skill set may be removed from the break candidate list, e.g., as received in 514.

Update schedule and notify agent 524: finally, and for example based on the calculated or computed allocation or assignment matrix and corresponding steps 508-520, if the break extendee list is not empty, embodiments may update or adjust the relevant schedule or schedules (which may include or involve, e.g., automatically augmenting or extending breaks for a plurality of agents or resources) and notify all affected agents with of the relevant schedule changes as further described herein.

One skilled in the art may recognize that additional or alternative steps and operations, e.g., not included or discussed with reference to FIG. 5, may be included in break extension or task and/or resource scheduling according to different embodiments of the invention.

As noted herein, some embodiments of the invention may run a simulator for predicting allocation requirements (which may for example be included or used in an allocation matrix such as, e.g., discussed with regard to 508 in FIG. 5).

In some embodiments, an allocation simulator may receive multiple standardized inputs for a time interval to be simulated. Example such inputs to the simulator may be items such as task or job properties such as, e.g., described herein and including a volume of tasks, interactions, or contacts (for example relating to one or more skills) and expected duration of tasks or calls for a given skill (which may be or may include the AHT for tasks of that skill, as may, e.g., be obtained from forecast data such as for example discussed herein)—and/or the number of agents available to handle tasks or calls, and the like. Upon receiving these inputs, embodiments may initiate a simulation, which may consider or describe events such as incoming tasks or calls being assigned to agents, calls starting or ending, and so forth. At each state along the time interval being simulated, the state of the agents and tasks or contacts may be calculated or predicted, and tracked or collected—and at the end of the simulation, statistics may be calculated.

Various simulators and simulation frameworks (including, for example, agent based modelling software suites and platforms such as for example the NetLogo agent based modelling platform and/or discrete event based simulation frameworks such as ones provided by the SimPy Python library or the DESMO-J Java library—although additional and/or alternative options may be used) are known in the art may be used for simulating or predicting allocation requirements according to different embodiments of the invention. In some embodiments, inputs to the simulator may include the forecasted volume or volumes and AHTs per skill, and may include target service metrics, queue setup, and the like. Given volumes and AHTs, the simulator may create a timeline, distributing the tasks included in the input task volumes during the simulated time interval. Such distribution over the timeline may for example be randomly generated, or evenly spread across the simulated time interval. Once the simulation begins, events may be serially handled, and the result of each event may be saved.

In some embodiments of the invention, a simulator may add an agent to the available allocation (which may be expressed as an allocation matrix such as, e.g., described herein) or to the set of available agents or resources every time a task or contact must be handled, and in case all the existing agents or resources are already busy handling previous or existing tasks or events. Once the simulated period or time interval reaches its end or is over, statistics and/or service metrics may be calculated. In some embodiments, calculated quantities may include, for example, a maximum number of active agents during the interval, a plurality of task properties or metrics (such as for example volumes and AHTs calculated for the simulated data, e.g., as opposed to properties calculated for, or based on, forecasted data or actual agent activity—such as, e.g., described herein), agent idle time or time during which resources are idle, and the like. Additional or alternative quantities or variable values may be calculated, e.g., as part of simulations carried out by different embodiments of the invention.

In some embodiments, inputs for simulators or simulations may be taken or collected in the middle of the time interval to be simulated, or at a “mid interval” state. A simulation may be run or executed to predict allocation requirements for the remaining time of the interval and, for example, for an additional time interval or timeframe of, e.g., another 15 minutes or more. The additional timeframe or period may be set, depend on, or be chosen based on, the flexibility and/or extent desired for future breaks to be optimized (for example, in some nonlimiting embodiments, breaks extensions and/or adjustments may be allowed for 5 subsequent (e.g., future) time intervals following the present time interval used from which data was extracted, while other nonlimiting embodiments may only allow extensions and/or adjustments within one half of the next, subsequent time interval). Embodiments may thus set the simulation timer, skill queues, agent availability queues and other simulation elements describing the simulation contents or states, to the values corresponding to, e.g., the real states of relevant resources (as, e.g., existing in a contact center) in real time or at present time within the time interval considered, or “mid interval”, and then running the simulation from these states onwards, until the end of that time interval.

As an illustrative, non-limiting example, say that at 13:07, out of the 3 agents in a contact center, agent 1 may be handling a call for the last 3 minutes. Agent 2 may be handling a call that started 15 seconds ago, and agent 3 may be free. No calls are waiting in ACD queues and 1 more call of contact may be expected to reach the contact center during this interval. A simulation may be set with these values describing a mid interval state of the contact center, and may provide a more accurate prediction for the state of the contact center during the future intervals. Such simulation may be more precise as the inputs to the simulator may be less hypothetical, and much more grounded in the real-time data and states of agents within the contact center. The output of the simulator may be, e.g., predicted allocation requirements (described, for example, using an allocation matrix) for each interval, which may be fed into additional operations relating to resource and break scheduling as further described herein.

In some embodiments of the invention, and as known in the art of simulation technology and science—a simulator (such as, e.g., an allocation or scheduling requirements simulator) may be used to compute problems that cannot be simply represented as a mathematical formula and/or solved analytically. Accordingly, a requirements simulator may be, for example, a software component comprised of a plurality of elements or inputs that may be initialized with specific values prior to simulation run. Elements required for initialization may include, for example:
a. Expected arrival time for tasks or interactions and expected durations. Forecasted task volumes may be spread across the timeline for a simulated interval and transformed into events going to occur at a specific moment in time. This can be done in multiple ways, such as, e.g., by evenly distributing the forecasted volume across the simulated period of time. Each event of an interaction starting is paired with an event of the interaction ending (for example, according to or based on forecasted AHTs as described herein).
b. Agents available to handle the incoming volume or workload and their skills for the interval to be simulated may be input to the simulator. These may be set into queues of availability according to their skill sets. At the beginning of the interval, all agents are placed into multiple queues that may be predefined or set according to the skills available for all agents in the set of available agents.

A nonlimiting example requirements simulator which may be applied to present and/or future time intervals, may include or involve example components, activity and operation which may, for example, be described in the following points:

1. Simulator components:
a. A set of available agent queues, or queues of agents available to work or perform tasks of a given skill during the time interval considered—which may include for example one queue per skill required for the time interval.
b. An event timeline describing the time interval considered, with start and end events for each task or contact, for a plurality of agents.

2. Inputs:
a. Forecast—volume and AHTs (for example per each skill and/or corresponding skill queue), as for example illustrated and discussed with regard to FIG. 6.
b. Available agents, or agents available to perform tasks at start of a time interval (which may be, e.g., imported or fetched from a schedule or a plurality of schedules determined and/or stored for the interval by appropriate components such as for example described herein).
c. Engaged agents (which may be, e.g., agents already handling tasks at the starting point of a simulation, e.g., mid interval) and start/end times of engagements for tasks within the interval before simulator initiation (which may also be fetched from schedule data such as for example described herein).

3. Initialization:
a. A timeline of start and end events may be initialized or assembled according to forecast data. For example, some embodiments may spread or distribute a forecasted volume along the event timeline and add end event for each task (which may for example be assumed to have a duration equal to the forecasted AHT time.
b. Available agents may be initialized or placed in skill queues for the interval.
c. Engaged agent names and/or may be pinned or assigned to end events.

4. Simulation run:
a. Events in the timeline may be extracted chronologically from skill queues.
b. If an event is a start event, an available agent may be looked for in the available agent queues that may have the relevant skill or skills in their skill set or group required to handle a corresponding pending task.
c. If a free agent is found, the free agent's name may be pinned to the end event of the matching the start event.
d. If no agent is available, a ‘wait’ or ‘hold’ count may be started or initiated, and take place, e.g., until an end event that may free an agent with a skill required to handle the pending task.
e. Upon an end event, the agent pinned to end event may be placed back in the relevant available agent queue.

5. Simulation results and output:
a. Predicted service metrics and/or task properties and/or a corresponding allocation matrices (such as, e.g., ones described herein in Table 2 and/or with reference to FIG. 6) may be calculated and be returned or provided as output.
b. Simulation may rerun or be initialized again, e.g., with increased or different available allocation or different numbers of available agents, e.g., until required service metrics are met, then the corresponding allocation may be returned or provided as output.

It should be noted that additional or alternative simulator components, as well as simulation operations as well as related schemes, frameworks, and the like—may be used in different embodiments of the invention. One skilled in the arts of modeling and simulation may consider or realize various simulations and/or models that may be used to provide predicted service metrics and/or task properties and/or allocation matrices such as for example described herein.

FIG. 6 shows an example schedule and forecasting results according to some embodiments of the invention. As discussed herein, a schedule may be for example a matrix and may include a plurality of time intervals or periods 602 during which agent activity entries 604 may be provided. In some embodiments, the schedule and activity entries 604 may, e.g., be a skill queue and correspond to a specific skill, feature or channel queue, such as, e.g., “data transfer”, “memory intensive computation”, “wireless communication”, “Bluetooth communication”, and the like (other examples relating, for example, to human agents may be, e.g., “technical support”, “sales”, “chat”, “voice call”, etc). An “open” entry may indicate that the agent may be open for work, or open for accepting and handling tasks (e.g., of the skill corresponding to the skill queue). Forecasted data may include, for example, task or interaction volume 606, AHT per task 608 and net allocation 610 for a relevant skill (e.g., that corresponding to the skill queue). During planning, a schedule may be calculated or constructed to satisfy, or to fit perfectly to the contact center's needs, which may be indicated by net allocation 610 having 0 values, and describing that neither overallocation, nor underallocation, is taking place.

It may be seen that agent n 612 has a break during the interval starting at 10:15. Agent n 612 may thus be considered as a break extension candidate by some embodiments of the invention. In some embodiments, scheduled data (e.g., activity entries 604) and forecasted data (e.g., volume 606, AHT 608—and net allocation 610, which may be for example an allocation matrix as demonstrated herein—which may be, in this particular case, a vector describing allocation requirements for a plurality of time intervals for a single skill) may be provided or output at a planning phase—e.g., before break extension as discussed herein may be considered—and may created in advance, e.g., months ahead of the time during which the schedule is to be executed.

A simulation may be performed for the time intervals and agent queues described using activity entries 604—e.g., using an allocation or event simulator as described herein—to provide a reforecasted Volume 616, reforecasted AHT 618 and reforecasted NetAllocation 620 (which may be, e.g., an allocation matrix or vector similar in form to net allocation 610). It may be seen that while reforecasted AHT 618 has remained unchanged with respect to the original AHT 608—reforecasted volume 616 was predicted to decrease (with respect to the original volume 606) for the first three intervals of intervals 602. This in turn may result in the NetAllocation 620 containing positive values, or values larger than 0 for the first three intervals considered (indicating, e.g., that relevant resources may be overallocated, or may have a capacity to handle more tasks than required using the skill under consideration). On the 3^{rd} interval (which may correspond, e.g., to the time period between 10:45 and 11:00), NetAllocation 620 has reached 1, meaning or indicating that an overallocation by 1 single resource or agent is likely based on the reforecasted schedule. Following simulation based reforecasting 614, break extender service 622 may be called (and may be executed, e.g., using components 202 or 302 as described herein), and use updated or reforecasted values (such as for example reforecasted Volume 616, reforecasted AHT 618 and reforecasted net allocation 620) as inputs. Break extender service 622622 may generate break extension candidates 624—which may be resources or agent that have breaks within the schedule considered. In the example described in activity entries 604, agent n 612 may thus be the only viable option, and may accordingly be selected (626) as a break extension candidate by embodiments of the invention. Since during the period or interval 10:45-11:00, an overallocation of 1 agent is indicated in reforecasted NetAllocation 620, subtracting or excluding 15 minutes of work (which may amount to the work done or tasks handled by 1 entire agent or resource for the period considered) from the schedule for this period or interval may results in the net allocation equaling 0. Thus, meaning the algorithm may suggest extending the break of agent n 612 to include 15 additional minutes (628), and to cover the time period of 10:45-11:00 in addition to that of 10:15-10:45. A break for agent n 612 may accordingly be automatically extended, and agent n 612 may be notified, e.g., using a graphical user interface or display such as for example described herein (630).

One skilled in the art would recognize that additional or alternative schedule formats, forecasted or reforecasted data or metrics, and resource or agent selection algorithms and procedures, as well as selection conditions or criteria may be used in different embodiments of the invention.

FIG. 7 shows an example user interface for displaying schedule modifications according to some embodiments of the invention. A schedule 702 may include a plurality of events, including for example a plurality of tasks for execution and breaks throughout a plurality of time intervals. It may be seen that agent may receive alerts or notifications 704, for example while in break 706—saying that their break was automatically extended while giving the agent an option to decline the break extension by pressing a “decline” icon 708 and follow the original schedule prior to break extension. One skilled in the art would recognize that additional or alternative user interfaces may be used for displaying schedules and/or schedule changes, and for sending or receiving alerts and/or notifications, in different embodiments of the invention. A user interface such as illustrated in FIG. 7 may be, for example, implemented in an agent terminal or computer system such as for example a terminal among agent terminals 312 discussed herein with regard to FIG. 3.

In some embodiments of the invention, a changing or updating of a schedule may include for example automatically transmitting a task execution command to a relevant resource, such as, e.g., a physically separate or remote computer, e.g., over a communication network. In some embodiments, such task execution command may be included in an updated schedule provided to the relevant resource or resources, e.g., as an output of a resource allocation or adjustment procedure such as for example outlined in FIG. 5, although other forms or formats of commands may be realized and used in different embodiments of the invention. Based on a task execution command, a resource such as, e.g., a remote computer may automatically execute a plurality of computer tasks—or automatically cancel an execution (such as for example an execution previously scheduled before break extension or adjustment was performed) of a plurality of computer tasks—based on, or according to the schedule calculated, updated, or adjusted for example according to protocols and procedures described herein. One skilled in the art of computational resource allocation may realize various automated actions may be taken based on appropriate commands and, for example, schedules calculated or adjusted by different embodiments of the invention.

Embodiments of the invention may automatically change the routing of an interaction or task (e.g., using appropriate components and procedures described with reference to FIGS. 3-4), e.g., according to brake adjustment or extension related protocols and procedures such as for example described herein. For example, if an agent or resource was selected for break extension, and embodiments of the invention may automatically change the routing of a task such that, e.g., it may be routed to an agent or resource different from the extension candidate, which may for example be selected randomly from the extension candidate list described herein (in such manner, for example, the task may be removed from the time interval following the original break for the extension candidate such that its break may in fact be extended). Some embodiments may automatically edit or update schedule and/or routing tables or data structures to change the scheduling and/or routing of a task, e.g., to make break extension possible for extension candidates—and then route or reroute the relevant tasks to agents different from the break extension candidate, for example in real time, while the task or interaction is on hold. In this context, many call or data routing and/or network based transmission protocols may be used for routing or rerouting tasks or interactions by different embodiments of the invention.

Embodiments of the invention may improve resource and/or task scheduling technology by effectively and automatically revising or adjusting schedules, and/or by rescheduling and/or routing or rerouting tasks based on accurate real time data and/or information. This may allow for optimized utilization of resources and for preventing inefficient resource usage and resource attrition or degradation, e.g., due to wasteful resource usage and/or scheduling which may be found unnecessary with regard to the actual volume of incoming tasks to be handled by the relevant resources.

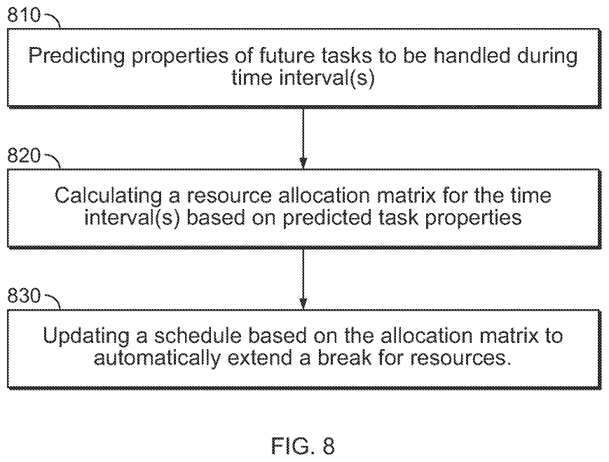

FIG. 8 is a flowchart depicting an example method for intelligent resource schedule adjustment according to some embodiments of the invention. In step 810, embodiments may predict, for a plurality of time intervals, a plurality of task or job properties or metrics, where each of the properties or metrics may describe future tasks to be handled during the relevant time intervals. Embodiments may then calculate an allocation or assignment matrix for the time intervals based on predicted properties or metrics—where the matrix may describe a capacity of a plurality or a set of resources to handle the future tasks (step 820). Embodiments may then update a schedule to extend or augment a break for one or more of the resources based on the calculated allocation or assignment matrix (step 830), where the resources are not to handle tasks during their break.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method of resource scheduling, the method comprising, using a computer processor:
for one or more time intervals, predicting, by the processor, a plurality of task properties, each of the task properties describing one or more future tasks to be handled by one or more resources;
calculating, by the processor, an allocation matrix for the one or more time intervals based on the predicted task properties, the allocation matrix describing a capacity of the resources to handle the future tasks; and
updating, by the processor, a schedule based on the calculated allocation matrix, the updating of the schedule comprising automatically extending a break for one or more of the resources, wherein the resources are not to handle tasks during the break.

2. The method of claim 1 wherein the calculating of an allocation matrix comprises removing one or more of the resources from the allocation matrix, wherein the removing of resources is performed for one or more positive matrix entries, the positive entries representing an excess allocation for one or more of time intervals.

3. The method of claim 1, wherein the task properties comprise: a volume of tasks, and an average handling time per task.

4. The method of claim 1, wherein the predicting of the task properties comprises weighting one or more past predictions for the one or more time intervals, the weighting based on comparing the past predictions to a plurality of past task data, the past task data comprising start and end times of a plurality of tasks handled.

5. The method of claim 4, wherein the calculating of an allocation matrix comprises running a simulation based on: one or more of the task properties, a set of available resources, and the plurality of past task data.

6. The method of claim 5, wherein the simulation is executed during the one or more time intervals, and wherein the past task data describes the one or more time intervals prior to running the simulation.

7. The method of claim 1, wherein the extending of a break is performed for one or more randomly selected resources among the one or more resources.

8. The method of claim 1 comprising transmitting, by the processor, a task execution command to a remote computer over a communication network, the remote computer to automatically cancel an execution of at least one computer task based updated schedule.

9. A computerized system for resource scheduling, the system comprising:
a memory; and
a computer processor configured to:
for one or more time intervals, predict a plurality of task properties, each of the task properties describing one or more future tasks to be handled by one or more resources;
calculate an allocation matrix for the one or more time intervals based on the predicted task properties, the allocation matrix describing a capacity of the resources to handle the future tasks; and
update a schedule based on the calculated allocation matrix, the updating of the schedule comprising automatically extending a break for one or more of the resources, wherein the resources are not to handle tasks during the break.

10. The system of claim 9, wherein the calculating of an allocation matrix comprises removing one or more of the resources from the allocation matrix, wherein the removing of resources is performed for one or more positive matrix entries, the positive entries representing an excess allocation for one or more of time intervals.

11. The system of claim 9, wherein the task properties comprise: a volume of tasks, and an average handling time per task.

12. The system of claim 9, wherein the predicting of the task properties comprises weighting one or more past predictions for the one or more time intervals, the weighting based on comparing the past predictions to a plurality of past task data, the past task data comprising start and end times of a plurality of tasks handled.

13. The system of claim 12, wherein the calculating of an allocation matrix comprises running a simulation based on: one or more of the task properties, a set of available resources, and the plurality of past task data.

14. The system of claim 13, wherein the simulation is executed during the one or more time intervals, and wherein the past task data describes the one or more time intervals prior to running the simulation.

15. The system of claim 9, wherein the extending of a break is performed for one or more randomly selected resources among the one or more resources.

16. The system of claim 9, wherein the processor is to transmit a task execution command to a remote computer over a communication network, the remote computer to automatically cancel an execution of at least one computer task based updated schedule.

17. A method of resource allocation, the method comprising, using a computer processor:
for one or more time periods, computing, by the processor, a plurality of job metrics, each of the job metrics describing one or more future jobs to be handled by one or more resources;
computing, by the processor, an assignment matrix for the one or more time periods based on the computed job metrics, the assignment matrix describing a capacity of the resources to handle the future jobs; and
adjusting, by the processor, a schedule based on the calculated assignment matrix, the adjusting of the schedule comprising automatically augmenting a break for one or more of the resources, wherein the resources are not to handle tasks during the break.

18. The method of claim 17, wherein the calculating of an assignment matrix comprises removing one or more of the resources from the assignment matrix, wherein the removing of resources is performed for one or more positive matrix entries, the positive entries representing an excess assignment for one or more of time periods.

19. The method of claim 17, wherein the job metrics comprise: a volume of jobs, and an average handling time per job.

20. The method of claim 17, wherein the computing of the job metrics comprises normalizing one or more predictions for the one or more time periods, the normalizing based on comparing the predictions to a plurality of past job data, the past job data comprising start and end times of a plurality of jobs handled.
